(19) United States
(12) Patent Application Publication
(10) Pub. No.: US 2005/0072534 A1
(43) Pub. Date: Apr. 7, 2005

(54) Clutch mechanism for a roller blind

(75) Inventor: Peter Braybrook, Gloucester (GB)

Correspondence Address: YOUNG & THOMPSON, 745 SOUTH 23RD STREET, 2ND FLOOR, ARLINGTON, VA, 22202, US

(73) Assignee: LEVOLUX A. T. LIMITED, GLOUCESTER (GB)

(21) Appl. No.: 10/887,091

(22) Filed: Jul. 9, 2004

(30) Foreign Application Priority Data
Oct. 1, 2003 (GB) 0322955.6

(51) Int. Cl. E06B 9/26

(52) U.S. Cl. 160/167 R

(57) ABSTRACT

A clutch mechanism for a roller blind, comprises a housing, a drive member journalled for rotation within the housing, a hub portion projecting from the front of the housing, a C-shaped leaf spring, which has in-turned ends, mounted in the hub portion for frictional engagement with the internal wall of the hub portion, a boss rotatable with the drive member and extending within the C-shaped spring so that rotation of the boss by the drive member causes the spring to close slightly thereby reducing the frictional engagement between the spring and the hub, and a driven member rotatably mounted on the hub for operating the roller blind. The driven member has a lug which projects into the space between the ends of the C-shaped spring so that any tendency to rotate the driven member by the weight of a partly lowered blind causes the C-shaped spring to open slightly and increase its frictional engagement with the hub.

This invention relates to a clutch mechanism for a roller blind.

Known clutch mechanisms for roller blinds make use of a coiled helical spring having overlapping ends to prevent a reverse torque applied by the weight of the blind from rotating the clutch. Examples of such mechanisms are disclosed in U.S. Pat. No. 5,361,822 and U.S. Pat. No. 6,164,428.

The coiled helical springs of these known mechanisms are expensive to make and difficult to manufacture to the very accurate tolerances necessary to make them work.

The present invention seeks to provide a simpler and less expensive clutch mechanism.

### SUMMARY OF THE INVENTION

According to the present invention there is provided a clutch mechanism for a roller blind, comprising a housing, a drive member journalled for rotation within the housing, a hub portion projecting from the front of the housing, a C-shaped leaf spring, which has in-turned ends, mounted in the hub portion for frictional engagement with the internal wall of the hub portion, a boss rotatable with the drive member and extending within the C-shaped spring so that rotation of the boss by the drive member causes the spring to close slightly thereby reducing the frictional engagement between the spring and the hub, and a driven member rotatably mounted on the hub for operating the roller blind, the driven member having a lug which projects into the space between the ends of the C-shaped spring so that any tendency to rotate the driven member by the weight of a partly lowered blind causes the C-shaped spring to open slightly and increase its frictional engagement with the hub.

Preferably, the driven member has a dome-shaped portion for fitting within the end of the roller blind. This dome-shaped portion facilitates insertion of the driven member into the end of the roller blind.

The invention will now be more particularly described, by way of example, with reference to the accompanying drawings.

### BRIEF DESCRIPTION OF THE DRAWINGS

FIG. 1 is a perspective exploded view of one embodiment of a clutch mechanism for a roller blind taken from the front, top and one side of the mechanism, and

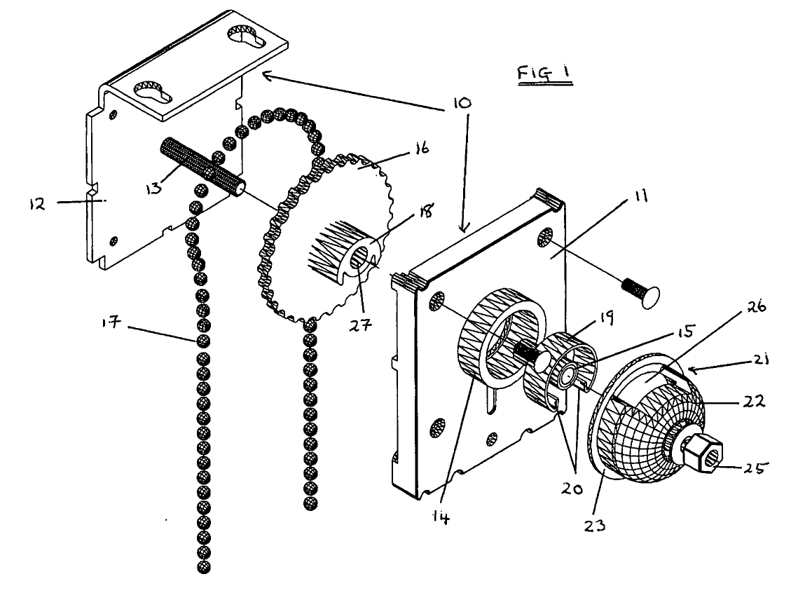

FIG. 2 is a perspective view of the clutch mechanism shown in FIG. 1 but taken from the rear, top and one side.

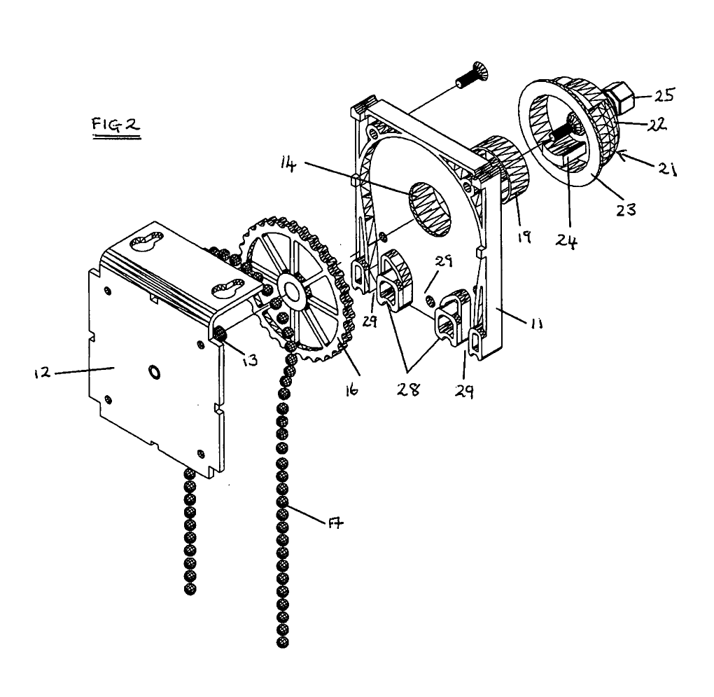

### DESCRIPTION OF THE PREFERRED EMBODIMENT

Referring to the drawings, the clutch mechanism shown therein comprises a housing 10 having a body part 11 and an L-shaped bracket part 12 which closes the rear of the body part 11 and which can be attached to a mounting surface (not shown).

The bracket part 12 has a threaded stud 13 projecting from its rear face, through the body part 11 and into and through a cylindrical hub 14 projecting from the front face of the body part 11. A bush 15 is mounted on the stud 13 and a sprocket wheel 16 is journalled for rotation on the bush 15.

The wheel 16 is designed for rotation by a ball chain 17 and has a forwardly projecting integral boss 18 which is also journalled for rotation on the bush 15.

A C-shaped leaf spring 19 having in-turned ends 20 is mounted in the hub 14 for frictional engagement with the internal wall of the hub 14.

A driven member 21 is mounted for rotation on the hub 14. This driven member 21 has a domed-shaped portion 22 to facilitate insertion into an end of a roller blind (not shown), a circumferentially extending flange 23 which prevents the end of the roller blind from making contact with the body part 11 of the housing and a lug 24 which projects into the hub 14 between the in-turned ends 20 of the C-shaped spring 19.

A nut 25 is threaded on the free end of the stud 13 to assemble the parts of the clutch mechanism together.

A recess 26 is provided in the dome-shaped portion 22 of the driven member 21 to key the roller blind to the driven member 21.

The boss 18 is of generally C-shaped cross section but is wider in its central region in order to provide for a through bore 27 which receives the bush 15. This boss 18 fits within the C-shaped spring 19 so that as the wheel 16 is driven by the ball chain 17, one end of the generally C-shaped boss 18 acts on the inside of one of the in-turned ends 20 of the spring 19 to cause the spring to close slightly and thereby reduce its frictional engagement with the internal surface of the hub 14. This enables the wheel 16 to rotate the driven member 21 and thereby the roller blind.

As stated previously, the lug 24 on the driven member 21 projects between the in-turned ends 20 of the spring 19. When a reverse torque is applied to the driven member 21 by the weight of a partly lowered roller blind, this lug 24 will act on one of the ends 20 of the spring 19 to open the spring 19 slightly and thereby increase its frictional engagement with the internal surface of the hub 14. The increase in frictional engagement between the spring 19 and the hub 14 will prevent this reverse torque from lowering the blind.

The body part 11 of the housing 10 has two guide members 28 at its lower end so as to define three discreet exit passages 29 for the ball chain 17. This enables the clutch mechanism to be installed with the two runs of the ball chain 17 exiting through the two side passages, or alternatively through one or other of the side passages and the central passage.

The above embodiment provides a simple, compact and inexpensive clutch mechanism for a roller blind. Also, the resistance of the spring within the boss is more equally distributed over a wider area than a coil spring providing a more effective resistance for braking and as such reduced wear to the internal surface of the boss. The dome shaped part 22 of the driven member 21 facilitates insertion of this driven member 21 into an end of a roller blind.

The above embodiment is given by way of example only and various modifications will be apparent to persons skilled in the art without departing from the scope of the invention as defined in the appended claims. For example, the spring 19 may be weakened by cut out portions adjacent to its in-turned ends 20 in order to enhance the degree of flexing of the spring by the boss 18 and lug 14.

1. A clutch mechanism for a roller blind, comprising a housing, a drive member journalled for rotation within the housing, a hub portion projecting from the front of the housing, a C-shaped leaf spring which has in-turned ends, mounted in the hub portion for frictional engagement with the internal wall of the hub portion, a boss rotatable with the drive member and extending within the C-shaped spring so that rotation of the boss by the drive member causes the spring to close slightly thereby reducing the frictional engagement between the spring and the hub, and a driven member rotatably mounted on the hub for operating the roller blind, the driven member having a lug which projects into the space between the ends of the C-shaped spring so that any tendency to rotate the driven member by the weight of a partly lowered blind causes the C-shaped spring to open slightly and increase its frictional engagement with the hub.

2. A clutch mechanism as claimed in claim 1, wherein the driven member has a dome-shaped portion for fitting within the end of the roller blind.

3. A clutch mechanism as claimed in claim 2, wherein the dome-shaped portion of the driven member has a recess therein for keying the driven member to the roller blind.

4. A clutch mechanism as claimed in claim 2, wherein the driven member has a circumferentially extending flange which prevents the end of the roller blind from making contact with the housing.

5. A clutch mechanism as claimed in claim 1, wherein the drive member is a wheel rotatable by a ball chain.

6. A clutch mechanism as claimed in claim 5, wherein the housing has means for guiding the ball chain outwardly therefrom along at least two alternative paths.

7. A roller blind including a clutch mechanism comprising a housing, a drive member journalled for rotation within the housing, a hub portion projecting from the front of the housing, a C-shaped leaf spring which has in-turned ends, mounted in the hub portion for frictional engagement with the internal wall of the hub portion, a boss rotatable with the drive member and extending within the C-shaped spring so that rotation of the boss by the drive member causes the spring to close slightly thereby reducing the frictional engagement between the spring and the hub, and a driven member rotatably mounted on the hub for operating the roller blind, the driven member having a lug which projects into the space between the ends of the C-shaped spring so that any tendency to rotate the driven member by the weight of a partly lowered blind causes the C-shaped spring to open slightly and increase its frictional engagement with the hub.
